(19) United States
(12) Patent Application Publication
(10) Pub. No.: US 2026/0247505 A1
(43) Pub. Date: Aug. 20, 2026

(54) LIGHTING APPARATUS

(71) Applicant: LEEDARSON LIGHTING CO.,LTD., Zhangzhou (CN)

(72) Inventors: Qiqiang Lin, Zhangzhou (CN); Hemu Ye, Zhangzhou (CN); Zongyuan Liu, Zhangzhou (CN); Zulun Hong, Zhangzhou (CN); Hao Chen, Zhangzhou (CN)

(21) Appl. No.: 19/181,265

(22) Filed: Apr. 16, 2025

(30) Foreign Application Priority Data
Apr. 17, 2024 (CN) 202410464751.2
Apr. 17, 2024 (CN) 202410465598.5

(51) Int. Cl. H05B 45/10; H05B 45/31; H05B 45/345; H05B 47/175; H05B 47/19; H05B 47/24; H05B 47/25

(52) U.S. Cl. CPC H05B 45/10; H05B 45/31; H05B 45/345; H05B 47/19; H05B 47/196; H05B 47/24; H05B 47/25

(57) ABSTRACT

A lighting apparatus includes a TRIAC signal detection circuit, a digital dimming signal input, a control processor and a power regulation circuit. The lighting apparatus supports dual-mode dimming-compatible power control. The TRIAC signal detection circuit is configured to detect a phase-cut dimming signal from a TRIAC wall dimmer. The digital dimming signal input is configured to receive a smart control signal selected from an I²C signal or a PWM signal. The control processor is communicatively coupled to the TRIAC signal detection circuit and the digital dimming signal input. The control processor is configured to perform a real-time mathematical operation combining the phase-cut dimming signal and the smart control signal. The power regulation circuit is configured to drive an LED load by adjusting an output current in response to a result of the real-time mathematical operation.

### FIELD

The present invention is related to a lighting apparatus, and more particularly related to a lighting apparatus support dual mode control.

### BACKGROUND

Over the past few decades, LED technology has advanced rapidly, offering a more energy-efficient and long-lasting alternative to traditional lighting. With continuous improvements in semiconductor materials and light conversion efficiency, LEDs have significantly reduced energy consumption while maintaining high brightness and durability. As a result, LED lighting has become a dominant force in the lighting industry, gradually replacing conventional light sources.

Traditional light bulbs, such as incandescent and fluorescent lamps, have been widely used for over a century. However, these light sources suffer from inefficiencies, short lifespans, and high energy consumption. Governments and industries worldwide have promoted the transition to LED lighting as a sustainable solution, aiming to reduce electricity usage and environmental impact. The shift towards LED technology is not only a response to energy concerns but also an opportunity to enhance lighting performance and design flexibility.

Among various LED applications, LED light bulbs have been developed to replace traditional filament-based bulbs. While they provide the benefits of higher efficiency and longer lifespan, some consumers still prefer the classic aesthetic of traditional light bulbs. The warm glow and familiar design of incandescent bulbs hold sentimental and decorative value, leading to a demand for LED alternatives that retain the nostalgic appeal of older lighting technologies.

To address this, flexible LED light strips have emerged as an innovative solution. By arranging LEDs on a bendable substrate, these strips can be shaped to mimic the look of filament-based bulbs, preserving the vintage aesthetic while offering superior energy efficiency and design flexibility. This approach allows LED light bulbs to maintain a classic appearance while integrating the advanced performance characteristics of modern LEDs.

Beyond aesthetics, flexible LED strips provide additional advantages over traditional light sources. Unlike rigid filaments, LED strips can be designed with customized light patterns, dynamic lighting effects, and precise control over brightness and color temperature. This versatility enables designers to create more sophisticated and adaptive lighting solutions, enhancing both functionality and visual appeal.

While flexible LED strips offer significant advantages, optimizing their cost is essential for widespread adoption. Manufacturing processes, material selection, and power efficiency must be carefully balanced to produce high-quality yet affordable lighting solutions. Reducing production costs while maintaining performance will determine the success of flexible LED technology in replacing traditional bulbs on a large scale.

In addition to cost considerations, light distribution patterns must be carefully engineered. Unlike point-source light from incandescent filaments, LED strips emit light along a surface, requiring innovative optical designs to achieve uniform illumination. Diffusers, reflectors, and lens coatings are essential components in shaping the emitted light to meet the expectations of consumers accustomed to traditional bulbs.

Durability and environmental factors also play a role in designing advanced LED lighting. Heat dissipation mechanisms, flexible yet sturdy materials, and resistance to moisture and dust must be considered to ensure reliability. The ability to withstand bending and twisting without compromising performance is crucial for maintaining the longevity of flexible LED light strips.

To further improve these lighting solutions, additional functionalities can be integrated. Smart lighting controls, dimmable features, and adaptive color tuning can enhance user experience, making LED bulbs not just a replacement but an upgrade over traditional lighting. The ability to adjust brightness and color temperature dynamically allows users to personalize their lighting environments for different moods and tasks.

As LED technology continues to evolve, the challenge lies in combining cost-efficiency, aesthetic appeal, and advanced functionality into a single innovative lighting device. By refining flexible LED strip designs and optimizing their integration into light bulbs, the industry can create next-generation lighting solutions that offer both the charm of traditional bulbs and the superior performance of modern LEDs.

### SUMMARY

In some embodiments, a lighting apparatus includes a TRIAC signal detection circuit, a digital dimming signal input, a control processor and a power regulation circuit.

The lighting apparatus supports dual-mode dimming-compatible power control.

The TRIAC signal detection circuit is configured to detect a phase-cut dimming signal from a TRIAC wall dimmer.

The digital dimming signal input is configured to receive a smart control signal selected from an I²C signal or a PWM signal.

The control processor is communicatively coupled to the TRIAC signal detection circuit and the digital dimming signal input. The control processor is configured to perform a real-time mathematical operation combining the phase-cut dimming signal and the smart control signal.

The power regulation circuit is configured to drive an LED load by adjusting an output current in response to a result of the real-time mathematical operation.

In some embodiments, the real-time mathematical operation is a multiplication of the phase-cut dimming signal and the smart control signal.

In some embodiments, the power regulation circuit includes a constant-current driver.

In some embodiments, the power regulation circuit includes a linear power supply with multiple output channels.

In some embodiments, the digital dimming signal input includes a pair of I²C input pins including an SDA pin and an SCL pin.

In some embodiments, the digital dimming signal input includes a PWM input pin.

In some embodiments, the output current is modulated by adjusting a reference voltage used in current sampling.

In some embodiments, the lighting apparatus may also include a wireless communication module configured to receive the smart control signal via Zigbee, WiFi, or BLE.

In some embodiments, the wireless communication module is configured to transmit the smart control signal to the control processor.

In some embodiments, the control processor and the power regulation circuit are integrated into a single integrated circuit.

In some embodiments, the TRIAC signal detection circuit includes a comparator and a voltage divider network coupled to an AC input.

In some embodiments, the control processor is further configured to output a PWM signal based on the phase-cut dimming signal.

In some embodiments, the lighting apparatus may also include a constant-voltage stage configured to convert an AC input to a PWM signal based on the phase-cut dimming signal.

In some embodiments, the PWM signal is supplied to the digital dimming signal input of a separate constant-current driver.

In some embodiments, the power regulation circuit includes at least three output channels for separately controlled LED segments.

In some embodiments, the apparatus is operable in a TRIAC-only dimming mode or a digital-dimming-only mode.

In some embodiments, the real-time mathematical operation is performed using an internal multiplier circuit within the control processor.

In some embodiments, the control processor includes logic to prioritize the smart control signal over the phase-cut dimming signal in the event of a conflict.

In some embodiments, the power regulation circuit further includes an over-voltage protection system and an over-current protection system.

In some embodiments, the apparatus is configured to operate with existing TRIAC dimmer installations without requiring modification to building wiring.

### BRIEF DESCRIPTION OF DRAWINGS

FIG. 1 is a schematic circuit diagram of an LED driver circuit according to an embodiment of the present invention.

FIG. 2 is another schematic circuit diagram of an LED driver circuit according to an embodiment of the present invention.

FIG. 3 is a circuit schematic diagram of an LED driver circuit according to an embodiment of the present invention.

FIG. 4 is a block diagram of the internal structure of a constant-current driving chip according to an embodiment of the present invention.

FIG. 5 is a schematic diagram of the internal principle of a constant-current driving chip according to an embodiment of the present invention.

FIG. 6 is yet another schematic circuit diagram of an LED driver circuit according to an embodiment of the present invention.

FIG. 7 is a circuit schematic diagram of a constant-voltage module according to an embodiment of the present invention.

FIG. 8 is another circuit schematic diagram of a constant-voltage module according to an embodiment of the present invention.

FIG. 9 is a block diagram of the internal principle of a constant-voltage control chip according to an embodiment of the present invention.

FIG. 10 is a schematic circuit diagram of an LED driver circuit according to an embodiment of the present invention.

FIG. 11 is another schematic circuit diagram of an LED driver circuit according to an embodiment of the present invention.

FIG. 12 is a circuit schematic diagram of an LED driver circuit according to an embodiment of the present invention.

FIG. 13 is a block diagram of the internal structure of a constant-current driving chip according to an embodiment of the present invention.

FIG. 14 is a schematic diagram of the internal principle of a constant-current driving chip with three-channel output according to an embodiment of the present invention.

FIG. 15 is a schematic diagram of the internal principle of a constant-current driving chip with single-channel output according to an embodiment of the present invention.

FIG. 16 is another lighting device embodiment of the present invention.

### DETAILED DESCRIPTION

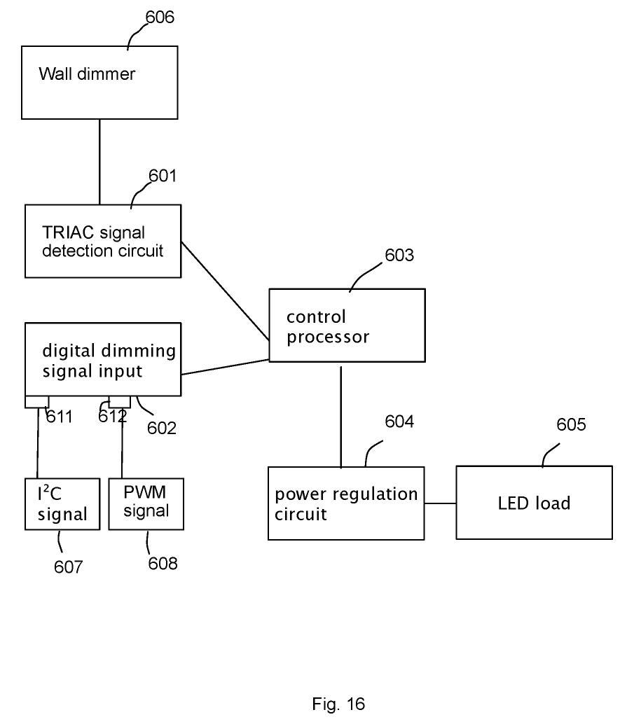

In FIG. 16, a lighting apparatus includes a TRIAC signal detection circuit 601, a digital dimming signal input 602, a control processor 603 and a power regulation circuit 604.

The lighting apparatus supports dual-mode dimming-compatible power control.

The TRIAC signal detection circuit 601 is configured to detect a phase-cut dimming signal from a TRIAC wall dimmer 606.

The digital dimming signal input 602 is configured to receive a smart control signal selected from an I²C signal 607 or a PWM signal 608.

The control processor 603 is communicatively coupled to the TRIAC signal detection circuit 601 and the digital dimming signal input 602. The control processor 603 is configured to perform a real-time mathematical operation combining the phase-cut dimming signal and the smart control signal.

The power regulation circuit 604 is configured to drive an LED load 605 by adjusting an output current in response to a result of the real-time mathematical operation.

In some embodiments, the real-time mathematical operation is a multiplication of the phase-cut dimming signal and the smart control signal.

In some embodiments, the power regulation circuit includes a constant-current driver.

In some embodiments, the power regulation circuit includes a linear power supply with multiple output channels.

In some embodiments, the digital dimming signal input includes a pair of I²C input pins 611 including an SDA pin and an SCL pin.

In some embodiments, the digital dimming signal input includes a PWM input pin 612.

In some embodiments, the output current is modulated by adjusting a reference voltage used in current sampling.

In some embodiments, the lighting apparatus may also include a wireless communication module configured to receive the smart control signal via Zigbee, WiFi, or BLE.

In some embodiments, the wireless communication module is configured to transmit the smart control signal to the control processor.

In some embodiments, the control processor and the power regulation circuit are integrated into a single integrated circuit.

In some embodiments, the TRIAC signal detection circuit includes a comparator and a voltage divider network coupled to an AC input.

In some embodiments, the control processor is further configured to output a PWM signal based on the phase-cut dimming signal.

In some embodiments, the lighting apparatus may also include a constant-voltage stage configured to convert an AC input to a PWM signal based on the phase-cut dimming signal.

In some embodiments, the PWM signal is supplied to the digital dimming signal input of a separate constant-current driver.

In some embodiments, the power regulation circuit includes at least three output channels for separately controlled LED segments.

In some embodiments, the apparatus is operable in a TRIAC-only dimming mode or a digital-dimming-only mode.

In some embodiments, the real-time mathematical operation is performed using an internal multiplier circuit within the control processor.

In some embodiments, the control processor includes logic to prioritize the smart control signal over the phase-cut dimming signal in the event of a conflict.

In some embodiments, the power regulation circuit further includes an over-voltage protection system and an over-current protection system.

In some embodiments, the apparatus is configured to operate with existing TRIAC dimmer installations without requiring modification to building wiring.

An embodiment is a dual-mode dimming-compatible power control apparatus that allows LED lighting products to respond intelligently and compatibly to both legacy analog wall dimmers and modern digital dimming protocols. One of the core components of this system is a TRIAC signal detection circuit. TRIAC (Triode for Alternating Current) dimmers are widely used in North America and Europe and operate by chopping parts of the AC waveform to control the brightness of lights. The detection circuit monitors the phase-cut signal, which reflects how early or late in the AC cycle the TRIAC switches on. This information is critical for interpreting the user’s intent when turning a dial or sliding a dimmer switch on the wall.

In addition to analog input compatibility, the apparatus includes a digital dimming signal input configured to accept control signals from smart systems. This input may handle either an I²C (Inter-Integrated Circuit) protocol or a PWM (Pulse Width Modulation) signal, depending on the system’s configuration. I²C is commonly used in microcontroller environments, allowing multiple smart control components—like mobile apps, voice assistants, or networked lighting hubs—to communicate using two data lines (SDA and SCL). PWM, on the other hand, represents the brightness level as a series of voltage pulses, with the duty cycle of the pulses determining the average power delivered to the load.

The apparatus includes a control processor that acts as the central logic unit. It is connected to both the TRIAC detection circuit and the digital dimming signal input, meaning it has access to both traditional and modern dimming inputs simultaneously. The control processor performs a real-time mathematical operation, typically multiplication, on the two signals. This enables a seamless blend of user control methods—if the user lowers the brightness using the wall switch, and a smart controller also applies a dimming value, the effective brightness can be adjusted proportionally. For instance, a TRIAC input indicating 70% brightness and a digital input indicating 50% would result in a calculated 35% effective brightness, ensuring no conflict or flicker arises.

The power regulation circuit in the apparatus serves to drive the actual LED load. It adjusts the output current based on the result of the signal multiplication done by the processor. This current adjustment is crucial for dimming LEDs correctly, as LEDs are current-driven devices—changing the current alters the brightness directly. The system typically includes a current sampling reference voltage (Vref), which can be modified dynamically to alter the output current level precisely and in real time.

To offer robust functionality, the system is designed to support various architectures. In some embodiments, the power regulation circuit is a constant-current driver, which maintains a stable output current to the LEDs regardless of input voltage fluctuations. This is ideal for applications where consistent illumination is needed and where variable input conditions are expected. In other embodiments, a linear power supply with multiple output channels is used to control separate LED zones or segments independently. For example, a single IC might provide three separate outputs (OUT1, OUT2, OUT3), each capable of dimming its respective LED load independently using the combined dimming signal.

The digital dimming signal input supports both I²C and PWM formats depending on the design. For I²C implementations, the input consists of two pins—SDA (Serial Data) and SCL (Serial Clock). These pins are typically connected to a microcontroller or wireless module, such as a Zigbee or BLE device. In PWM implementations, a single PWM pin receives square wave signals with varying duty cycles representing the desired brightness level. Designers can choose between these modes depending on integration requirements. For example, in a WiFi-connected bulb controlled by a phone app, the digital dimming signal might come from a cloud-connected ESP32 module outputting PWM.

A wireless communication module may be included in the system to enable integration with smart home environments. This module could be based on standard wireless protocols such as Zigbee, WiFi, or BLE (Bluetooth Low Energy), and is responsible for receiving user commands from apps or voice assistants. It then transmits the smart control signal—either directly or after processing—to the control processor. In some implementations, this module can also perform preprocessing of signals, such as multiplying the TRIAC and digital inputs itself before sending the final dimming signal to the main control circuit.

For cost-effective integration, the control processor and power regulation circuit may be housed within a single integrated circuit (IC). This integration reduces board space, simplifies manufacturing, and lowers the bill of materials (BOM). Internally, the IC may include an analog front end for signal detection, a multiplier for real-time signal processing, and MOSFET drivers for controlling current flow to the LED load. These design choices make the invention practical for both residential and commercial lighting applications.

To reliably detect TRIAC dimming signals, the system’s TRIAC signal detection circuit typically includes a comparator and a voltage divider network connected to the AC mains. The divider scales the high-voltage waveform to a manageable level, while the comparator detects when the waveform crosses a certain threshold—this crossing time indicates the TRIAC’s firing angle. The processor can then determine how early or late the TRIAC is triggering within the AC cycle, which correlates with user-set brightness.

Building on the previous explanation, it is important to understand how the control processor may also generate a PWM signal internally or pass through a processed signal as a PWM output. This allows the apparatus to interoperate with other components in a lighting system that require PWM inputs for brightness control. For instance, in a hybrid setup where some LED drivers are PWM-based and others are current-controlled, the processor’s ability to output a PWM signal helps maintain compatibility without needing additional circuitry. This makes the system more adaptable in diverse deployment environments, such as mixed commercial lighting installations.

The invention also supports modular architectures through the inclusion of a constant-voltage stage in certain embodiments. This stage, typically implemented with a switching or linear regulator, takes in the AC input and converts it into a regulated DC voltage. More significantly, it performs an analysis of the phase-cut signal from the TRIAC and transforms this analog waveform into a corresponding PWM signal. This PWM signal is then forwarded either directly to the digital dimming signal input of a downstream constant-current driver, or sent to a wireless controller for further processing. By isolating signal detection and dimming logic, this structure enhances modularity and reuse of existing smart driver ICs.

In some cases, the system includes a separate constant-current driver IC, especially when the TRIAC analysis is performed upstream by a voltage-regulation block. This separation of responsibilities allows each IC to focus on a distinct task: the first handles analog signal interpretation and power modulation, while the second performs fine-grained dimming control. For example, the constant-voltage block may output a PWM signal corresponding to 60% brightness based on the TRIAC input, and the downstream current driver may modulate current output further based on a 70% I²C command, resulting in an overall output of 42% via real-time multiplication logic.

The apparatus may include at least three output channels—OUT1, OUT2, and OUT3—on the power regulation circuit. Each output channel can independently drive a different segment or group of LEDs. This is especially useful in smart lighting fixtures where separate zones need to be controlled individually, such as RGB LED arrays or multi-beam luminaires. All channels are typically governed by the same control logic and receive the same composite dimming signal unless otherwise configured. Some applications may repurpose these channels for different tasks, such as zone-based ambient lighting, color temperature adjustment, or task lighting.

The invention is designed to operate in multiple dimming modes—including TRIAC-only, digital-only (I²C or PWM), and blended operation. In a TRIAC-only scenario, the system defaults to interpreting the wall dimmer’s input and adjusts current accordingly. In a smart-control-only scenario, the TRIAC detection logic can be idle or bypassed, and the LED output is governed entirely by wireless or digital commands. When both inputs are present, the processor can blend them using the multiplication logic. This multimodal capability ensures seamless integration regardless of the user’s environment or control preference.

A core part of the processor’s function is an internal multiplier circuit, which performs the real-time operation combining the two dimming signals. This is typically a digital multiplier that accepts either raw digital values (in the case of I²C) or digitized duty cycles (in the case of PWM). The result of the multiplication adjusts either a DAC (Digital to Analog Converter) output or a modulated reference voltage (Vref) to govern the current output. For example, if the TRIAC input is interpreted as 0.8 (80% brightness) and the I²C input as 0.6 (60% brightness), the multiplier outputs 0.48 (48%), which directly controls the current to the LED.

Another advanced feature of the invention is priority logic within the processor. This logic determines which dimming signal to prioritize in case of a conflict or degradation in signal integrity. For instance, if the TRIAC signal becomes noisy due to poor wiring or degradation of the wall dimmer, the system can automatically prioritize the digital dimming signal to maintain stable lighting. This ensures reliability and safety in diverse electrical conditions, and can also be user-configurable through software settings on the wireless control module.

To further enhance safety and robustness, the power regulation circuit includes over-voltage protection (OVP) and over-current protection (OCP). OVP ensures that the LEDs are not exposed to voltages beyond their rated limits, which could otherwise cause permanent damage or safety hazards. OCP monitors the current through the driver circuits and prevents it from exceeding specified thresholds. These protection mechanisms can be implemented using comparator circuits, current-sense resistors, and error amplifiers inside the driver IC.

The invention is particularly valuable in retrofit installations, where existing TRIAC wall dimmer infrastructure is already deployed. Instead of requiring the user to remove or replace wall dimmers—often a costly and labor-intensive task—the present system allows direct compatibility. The user may continue using their physical wall switch as normal, while the lighting system intelligently incorporates smart control inputs. For instance, turning a knob on the wall may reduce overall brightness, but still permit app-based control to fine-tune within that range. This backwards compatibility improves user satisfaction and lowers installation barriers.

Finally, the invention’s use of building wiring without modification further distinguishes it from traditional smart lighting systems that require additional signal lines or specialized interfaces. By working over the existing two-wire AC lines and interpreting the TRIAC phase angle as a data signal, the system becomes truly plug-and-play. Electricians and users alike can install the lighting fixture in standard sockets without additional setup. Wireless control can be enabled simply by pairing with a hub or mobile app. This approach provides the benefits of smart lighting without sacrificing compatibility with established infrastructure.

To implement the described system in a practical product, designers can select from a variety of commercially available integrated circuits (ICs) that support either constant-current or constant-voltage driving modes. For instance, a constant-current LED driver IC with built-in I²C or PWM dimming input pins can be used as the core of the power regulation circuit. The TRIAC signal detection can be added as a front-end block, often consisting of a resistive divider connected to the AC line, followed by a comparator or zero-cross detector. The key is to extract the timing of the TRIAC’s firing angle and convert it into a control signal usable by the processor or multiplier logic.

In applications where cost and simplicity are key, the TRIAC detection and signal multiplication may all be handled within a single IC that includes analog input processing, digital multiplication logic, and output drive stages. This level of integration minimizes board footprint and eases assembly for high-volume consumer products like smart bulbs. However, in more modular or professional lighting installations, the design may be split across multiple stages: a TRIAC signal interpreter, a wireless communication module (e.g., Zigbee, BLE), and a dimming driver. Each module can be updated or upgraded independently to accommodate changes in lighting standards or control protocols.

To build a prototype or proof-of-concept version of this invention, an engineer could use a microcontroller with ADC (Analog-to-Digital Conversion) capability to sample the AC waveform after rectification and apply software logic to detect the TRIAC phase-cut pattern. PWM signals can be generated using timer peripherals, while I²C communication can be implemented using built-in bus controllers. A basic DAC output or PWM-controlled analog circuit can adjust the Vref pin of a commercial constant-current LED driver. This approach allows rapid testing and firmware updates to refine the signal blending algorithm before committing to a full ASIC or custom IC.

Integration with smart home ecosystems is one of the primary benefits of the invention. The digital dimming signal input supports command reception via WiFi, BLE, or Zigbee networks. For example, a Zigbee module can receive brightness levels and color settings from a smart home hub (like Philips Hue or Amazon Echo), and convert them into PWM or I²C outputs to control the lighting. At the same time, the TRIAC input ensures the same lighting unit remains operable even if the smart hub is offline, ensuring user control is never lost. This dual-path control architecture enhances reliability and user trust in the system.

The user experience enabled by this system is significantly improved over legacy lighting systems. With the blended signal architecture, even small, incremental dimming changes using a physical knob will translate into responsive LED behavior, without flickering or cut-off. When the smart system takes over—say, during a scheduled nighttime dimming routine—the brightness transitions remain smooth and synchronized with the physical switch’s setting. This synergy prevents sudden brightness jumps or perceptual mismatches that commonly plague hybrid lighting systems without signal coordination.

Further embodiments of the invention could include feedback channels or sensors to monitor actual light output (via photodiodes or current measurement) and allow the system to auto-calibrate its dimming curve. This is especially important in environments with mixed ambient lighting, where perceived brightness may not match the intended setting. The system could also detect prolonged absence of TRIAC signal changes and infer that digital control should take precedence, or vice versa. These enhancements would be implemented in firmware on the processor or in an external MCU communicating via I²C.

In terms of standards compliance, the apparatus must meet EMC (Electromagnetic Compatibility) and safety regulations when deployed in residential or commercial settings. The TRIAC detection circuit should be designed to avoid injecting noise into the AC line or misinterpreting harmonic distortions. Appropriate filtering (such as RC snubbers or EMI chokes) may be required at the AC input. The wireless module must conform to FCC, CE, or equivalent radio certification requirements if it operates over 2.4 GHz ISM bands. These design considerations are essential to move from lab prototype to mass-market deployment.

One notable design advantage of the invention is that it enables incremental upgrades to lighting infrastructure. A user can replace one fixture with the new dual-mode compatible unit, test its functionality with both the existing wall dimmer and their smart hub, and gradually retrofit the rest of the environment. This is in contrast to systems that require wholesale infrastructure changes (e.g., new dimmer switches, rewiring, proprietary hubs). The backward and forward compatibility afforded by this apparatus makes it highly attractive to both residential and commercial lighting planners.

The software logic behind the signal multiplication and prioritization may reside in an embedded microcontroller or dedicated logic inside the IC. For example, the firmware could define adjustable weighting between the analog and digital dimming signals, allowing users to bias the system toward smart control or manual control depending on personal preferences. More sophisticated implementations could expose these settings through a mobile app or configuration utility, making the system more adaptable across regions with different lighting expectations and user habits.

In commercial or architectural lighting installations, the system’s ability to handle multi-channel outputs is especially useful. Separate channels may be used for controlling uplights and downlights, ambient strips, or independent color zones. The apparatus allows a single wall dimmer to simultaneously influence all zones via the TRIAC signal, while a smart controller modulates specific zones digitally. This layered control strategy opens new creative opportunities for lighting designers who want to merge simplicity and intelligence without complexity or cost escalation.

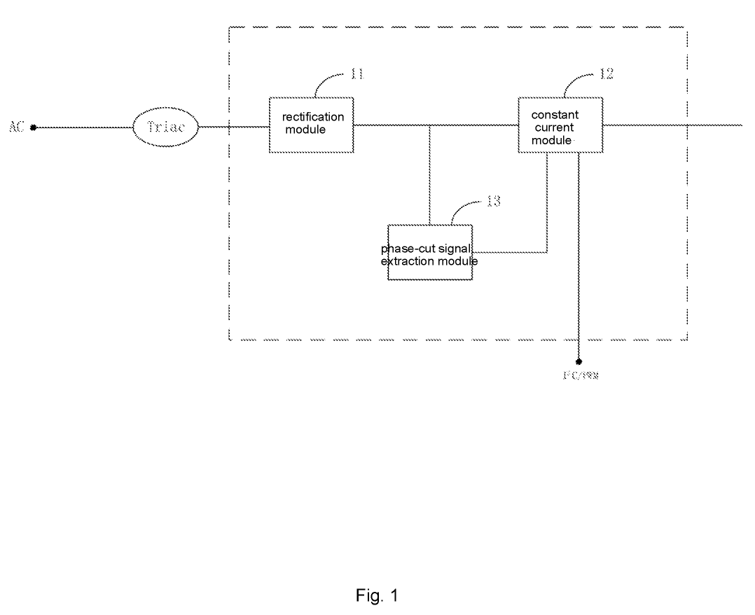

FIG. 1 is a schematic structural diagram of an LED driver circuit according to an embodiment of the present invention. Referring to FIG. 1, the input end of the LED driver circuit is connected to an AC power supply via a TRIAC dimmer, and the output end of the LED driver circuit is used to drive an LED load.

The LED driver circuit includes: a rectification module 11, a constant-current driving module 12, and a phase-cut signal extraction module 13.

The input end of the rectification module 11 is connected to the input of the LED driver circuit, and the output of the rectification module 11 is connected respectively to the input end of the constant-current driving module 12 and the input end of the phase-cut signal extraction module 13.

A first control end of the constant-current driving module 12 is connected to the output of the phase-cut signal extraction module 13, and a second control end is configured to receive a dimming signal. The output of the constant-current driving module 12 is connected to the output of the LED driver circuit.

The constant-current driving module 12 is configured to receive the dimming signal and the phase-cut signal from the phase-cut signal extraction module 13, and control its output current based on the combination of the dimming signal and the phase-cut signal.

In this embodiment of the invention, the constant-current driving module 12 handles compatibility between the phase-cut signal and the dimming signal. By controlling the output current based on both the dimming signal and the phase-cut signal, the system ensures consistent dimming. Since the phase-cut signal represents the firing angle of the TRIAC dimmer, the constant-current driving module 12 adjusts its parameters accordingly. This enables stable current regulation regardless of whether the TRIAC dimmer is set to a large or small angle, thereby preventing flickering problems at low dimming levels and enhancing compatibility of the driver circuit.

Simultaneously, the user may utilize both the TRIAC dimmer and a smart dimming signal for control, meeting diverse lighting adjustment needs. The driver circuit can be directly installed on power lines already equipped with TRIAC dimmers without requiring removal of the existing dimmer, simplifying installation and improving adaptability.

In one possible embodiment, controlling the output current of the constant-current driving module 12 based on the dimming signal and the phase-cut signal includes multiplying the two signals to generate a target dimming signal, and controlling the output current accordingly.

In this embodiment of the invention, the phase-cut signal reflects the firing angle of the TRIAC dimmer, which determines the total drive current. In conventional constant-current architectures, the parameters are typically set for maximum drive current. When the TRIAC angle changes, the actual drive current varies and may not match the preset parameters of the constant-current module, resulting in flickering at low dimming angles. To resolve this, this embodiment multiplies the dimming signal and the phase-cut signal to calculate the actual drive current and dynamically adjusts the parameters of the constant-current driving module 12 to maintain compatibility and improve performance of the LED driver circuit.

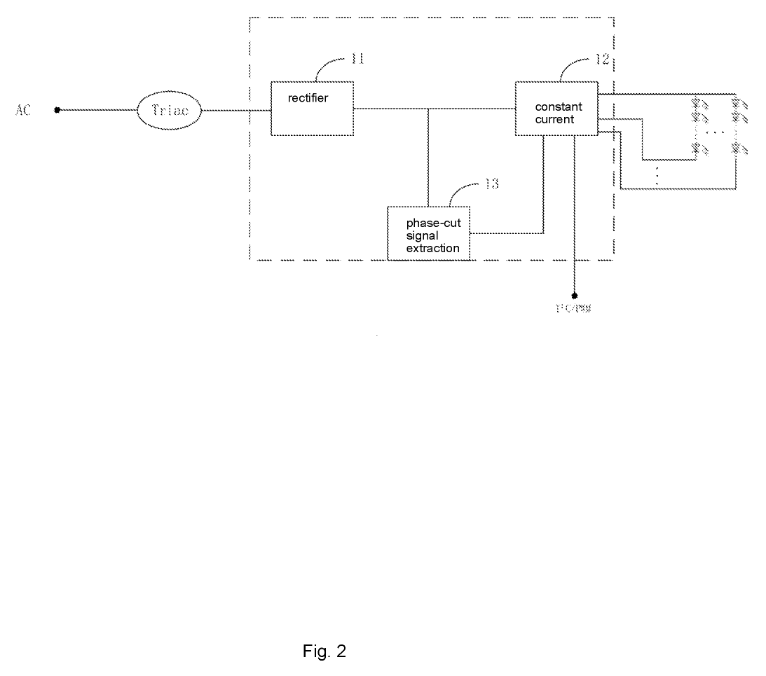

In one possible embodiment, referring to FIG. 2, the LED load may include at least one LED string. The constant-current driving module 12 may include a positive driving terminal and at least one negative driving terminal, with the number of negative driving terminals corresponding to the number of LED strings. The positive driving terminal is connected to the positive terminals of each LED string, and each negative driving terminal is individually connected to the corresponding negative terminal of each LED string.

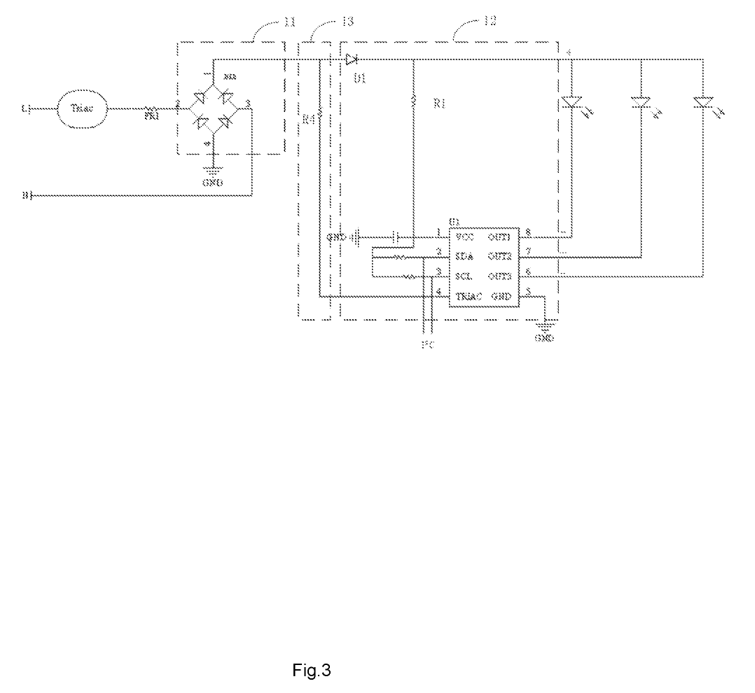

Referring to FIG. 3, the constant-current driving module 12 may include: a first diode D1, a first resistor R1, and a constant-current driving chip U1. The power supply terminal of the constant-current driving chip U1 is connected to both the cathode of the first diode D1 and the positive driving terminal via the first resistor R1. The first control signal input terminal of the constant-current driving chip U1 is connected to the first control end of the constant-current driving module 12, while the second control signal input terminal is connected to the second control end of the constant-current driving module 12. Each drain driving terminal of the constant-current driving chip U1 is connected to a corresponding negative driving terminal.

The anode of the first diode D1 is connected to the input of the constant-current driving module 12. The constant-current driving chip U1 multiplies the dimming signal with the phase-cut signal to generate a target dimming signal and controls the current of each drain driving terminal based on the target dimming signal.

To enable dimming and color tuning, multiple LED strings are typically used, such as warm white, neutral white, and cool white LED strings. These three LED strings are combined to realize tunable white lighting. In this embodiment, the dimming signal and the phase-cut signal are multiplied within the constant-current driving chip U1 to obtain a target dimming signal, which is then used to allocate current across each LED string, i.e., each drain driving terminal, achieving precise dimming control.

The first diode D1 is used for unidirectional conduction to prevent signals from the rear stages from interfering with the front-end circuit, which could affect the accuracy of phase-cut signal extraction. The first resistor R1 provides power to the constant-current driving chip U1.

Other peripheral components shown in FIG. 3 are based on conventional techniques and will not be described in detail here.

In one possible embodiment, the rectification module 11 may include a bridge rectifier BD1, as shown in FIG. 3. A fuse FR1 may be placed between the TRIAC dimmer and the rectification module 11 for overcurrent protection.

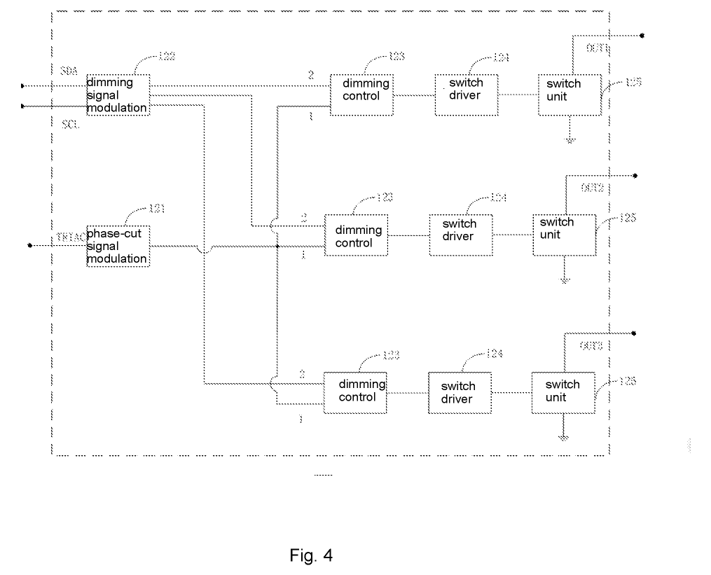

In one possible embodiment, referring to FIG. 4, the constant-current driving chip U1 may include: a phase-cut signal modulation unit 121, a dimming signal modulation unit 122, at least one dimming control unit 123, at least one switching driver unit 124, and at least one switching unit 125. Each dimming control unit 123 corresponds one-to-one with a switching driver unit 124 and a switching unit 125.

The input of the phase-cut signal modulation unit 121 is connected to the first control signal input terminal of the constant-current driving chip U1, and its output is connected to the first input terminal of each dimming control unit 123. The phase-cut signal modulation unit 121 is configured to convert the phase-cut signal into a PWM signal, thereby generating an adjusted phase-cut signal.

The input of the dimming signal modulation unit 122 is connected to the second control signal input terminal of the constant-current driving chip U1. Each output of the dimming signal modulation unit 122 is connected to a corresponding second input of a dimming control unit 123. The dimming signal modulation unit 122 is used to generate a secondary dimming signal for each dimming control unit 123 based on the dimming signal. The secondary dimming signal is a PWM signal.

For any given dimming control unit 123, its output is connected to the input of the corresponding switching driver unit 124. The output of the switching driver unit 124 is connected to the control terminal of the corresponding switching unit 125. The first terminal of the switching unit 125 is connected to the corresponding drain driving terminal of the dimming control unit 123, while the second terminal is connected to ground.

The dimming control unit 123 is configured to multiply the adjusted phase-cut signal with the corresponding secondary dimming signal to generate a target dimming signal for that channel. It then generates a reference voltage based on the target dimming signal. The switching driver unit 124 generates a switching control signal based on the reference voltage, which in turn controls the conduction of the corresponding switching unit 125, thereby regulating the current at the corresponding drain driving terminal.

For the constant-current driving chip U1, the phase-cut signal modulation unit 121 adjusts the phase-cut signal, for example by converting it into a PWM signal to facilitate further signal processing. The dimming signal modulation unit 122 similarly adjusts the dimming signal. For example, referring to FIG. 4, the dimming signal may be an I²C signal, which is also converted into a PWM signal. The dimming control unit 123 then multiplies the two PWM signals to generate a reference voltage. The reference voltage corresponds to the magnitude of the current at the drain driving terminal. The switching driver unit 124 controls the conduction state of the switching unit 125 based on the reference voltage, thereby regulating the output current.

The constant-current driving chip U1 supports both the phase-cut signal and the dimming signal, enabling compatibility with multiple dimming methods. This ensures precise dimming control and prevents issues such as flickering at low dimming angles.

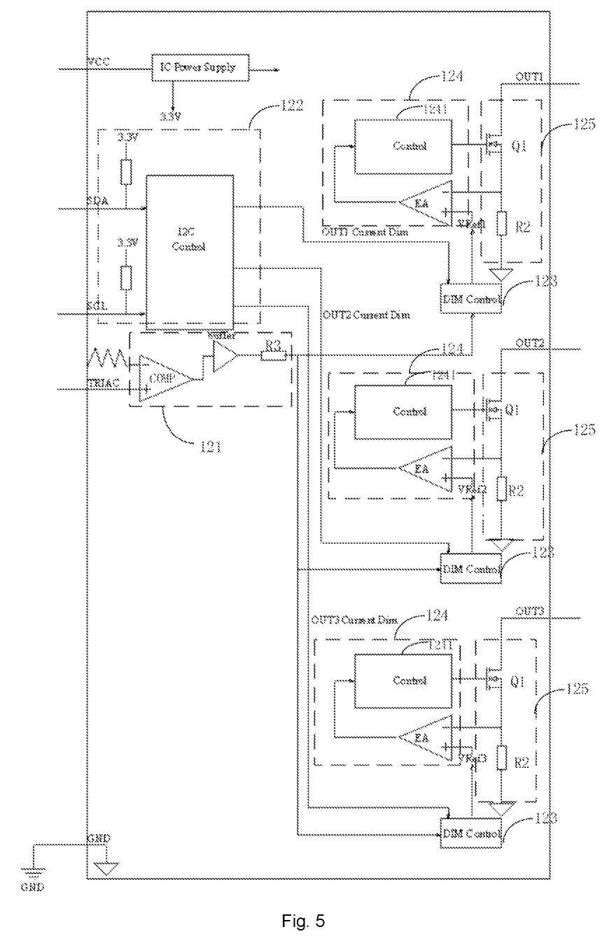

In one possible embodiment, referring to FIG. 5, the switching unit 125 may include: a first switching transistor Q1 and a second resistor R2. The first terminal of the switching transistor Q1 is connected to the first terminal of the switching unit 125. The control terminal of the switching transistor Q1 is connected to the control terminal of the switching unit 125. The second terminal of the switching transistor Q1 is connected to the second terminal of the switching unit 125 through the second resistor R2. The first switching transistor Q1 within the switching unit 125 is implemented using mature chip technology.

It should be noted that the above embodiment is merely illustrative. The first switching transistor Q1 and the second resistor R2 may alternatively be implemented externally and not integrated within the constant-current driving chip U1. This detail is not limited herein.

In one possible embodiment, referring to FIG. 5, the switching driver unit 124 may include: an error amplifier EA and a drive signal modulation subunit 1241 (Control). The positive input of the error amplifier EA is connected to the input of the switching driver unit 124. The negative input is connected to both the second terminal of the first switching transistor Q1 and the second resistor R2. The output of the error amplifier EA is connected to the input of the drive signal modulation subunit 1241. The output of the drive signal modulation subunit 1241 is connected to the output of the switching driver unit 124.

In this embodiment, the reference voltages (VRef1, VRef2, VRef3) are used to regulate the currents at the drain driving terminals. The drain current is proportional to the reference voltage. When the current at the drain driving terminal is lower than a preset current, the error amplifier EA amplifies the error and outputs a high-level signal to increase the duty cycle of the conduction of the first switching transistor Q1, thus increasing the current. Conversely, if the current is too high, the error amplifier outputs a low-level signal to reduce the duty cycle and reduce the current. In this way, precise current regulation is achieved for each channel.

In one possible embodiment, referring to FIG. 5, the phase-cut signal modulation unit 121 may include: a first comparator COMP and a third resistor R3. The positive input of the first comparator COMP is connected to the input of the phase-cut signal modulation unit 121, and the negative input is configured to receive a triangular wave signal. The output of the first comparator COMP is connected to the output of the phase-cut signal modulation unit 121 through the third resistor R3.

In this embodiment, the phase-cut signal is compared with the triangular wave signal. The resulting PWM signal has a duty cycle that increases as the firing angle of the TRIAC increases. Thus, the PWM signal reflects the TRIAC’s dimming level.

The third resistor R3 functions as a buffer. Additionally, as shown in FIG. 5, a buffer circuit may be added between the third resistor R3 and the first comparator COMP to improve signal stability and reliability.

When the number of LED strings is greater than one, and the dimming signal is an I²C signal, the specific circuit structure of the dimming signal modulation unit 122 may refer to FIG. 5 and is implemented using conventional techniques, so detailed explanation is omitted here.

When there is only one LED string and the dimming signal is a PWM signal, the dimming signal modulation unit may include resistors and a buffer. This configuration is similar to part of the circuitry used in the phase-cut signal modulation unit 121 shown in FIG. 5. The buffer and resistor are used for signal buffering.

It should be noted that FIG. 5 is merely a functional schematic diagram of the internal structure of the constant-current driving chip. Internal power and ground configurations are implemented using conventional techniques and are not shown in full in FIG. 5.

In one possible embodiment, referring to FIG. 3, the phase-cut signal extraction module 13 may include a fourth resistor R4. The first terminal of the fourth resistor R4 is connected to the input of the phase-cut signal extraction module 13, and the second terminal is connected to its output.

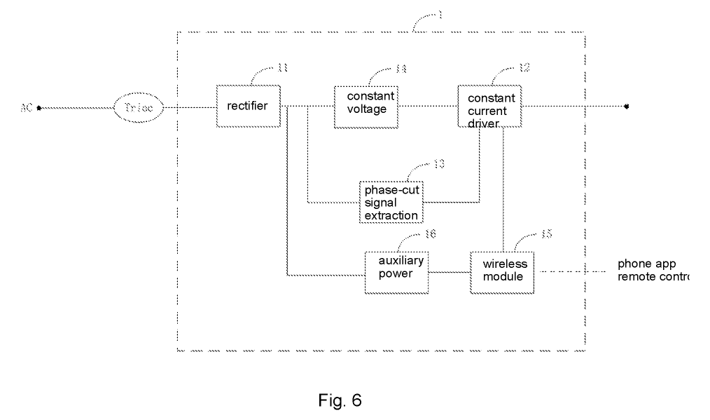

In one possible embodiment, referring to FIG. 6, the LED driver circuit may further include a constant-voltage module 14. The input of the constant-voltage module 14 is connected to both the output of the rectification module 11 and the input of the phase-cut signal extraction module 13. The output of the constant-voltage module 14 is connected to the input of the constant-current driving module 12.

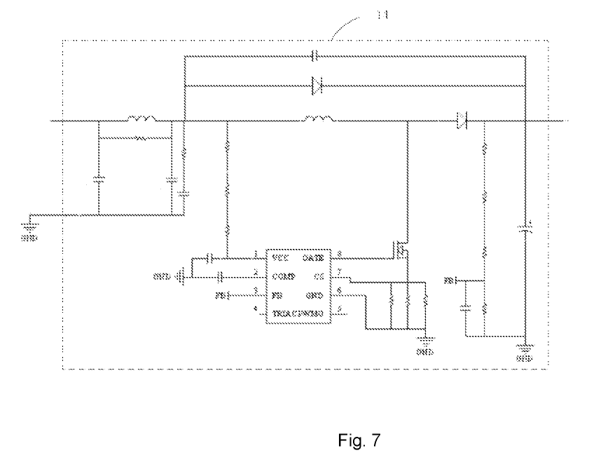

The output voltage of the constant-voltage module 14 is fixed. By incorporating the constant-voltage module 14, the LED supply voltage is stabilized, which enhances the reliability of the LED driver circuit. The circuit diagram of the constant-voltage module 14 can be found in FIG. 7 and is not detailed here.

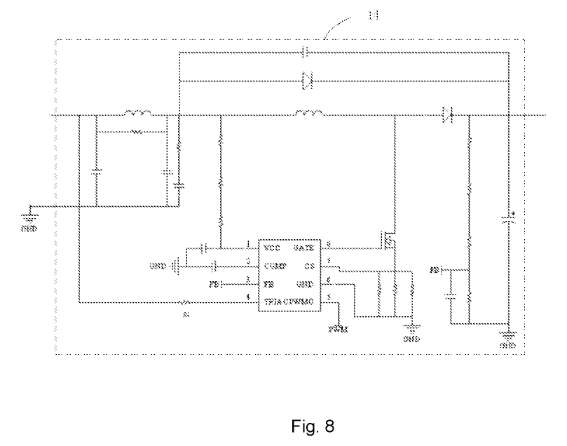

As shown in FIG. 7, the constant-voltage module 14 uses a control chip to implement constant-voltage regulation. Referring to FIG. 4 or FIG. 5, parts of the circuitry can be integrated into the chip of the constant-voltage module 14. For example, as shown in FIG. 8, the phase-cut signal is extracted by the phase-cut signal extraction module 13 via the fourth resistor R4, and the phase-cut signal modulation unit 121 is implemented within the control chip of the constant-voltage module 14. The resulting PWM signal is then sent to the constant-current driving chip U1. This approach reduces the size and complexity of the constant-current driving chip U1.

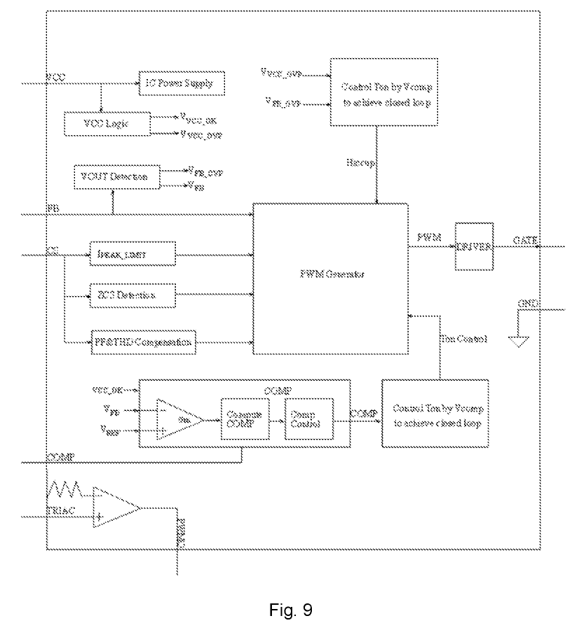

In the embodiment corresponding to FIG. 8, the internal block diagram of the control chip in the constant-voltage module 14 is shown in FIG. 9. This chip is used to perform both the constant-voltage regulation and the conversion of the phase-cut signal into a PWM signal. The specific working principle will not be elaborated here.

In one possible embodiment, referring to FIG. 6, the LED driver circuit may further include: a wireless communication module 15 and an auxiliary power module 16. The input of the auxiliary power module 16 is connected to the output of the rectification module 11 and is configured to supply power to the wireless communication module 15.

The wireless communication module 15 is configured to receive dimming signals sent from an external mobile phone application (APP) or remote control device and transmit the dimming signals to the constant-current driving module 12.

In a second aspect, the present invention further provides a lighting fixture, which includes any of the LED driver circuits described in the above embodiments. This lighting fixture inherits all of the advantages associated with the described LED driver circuit, and for brevity, further details are not repeated here.

Below is a detailed description of the implementation of the present invention in conjunction with specific drawings:

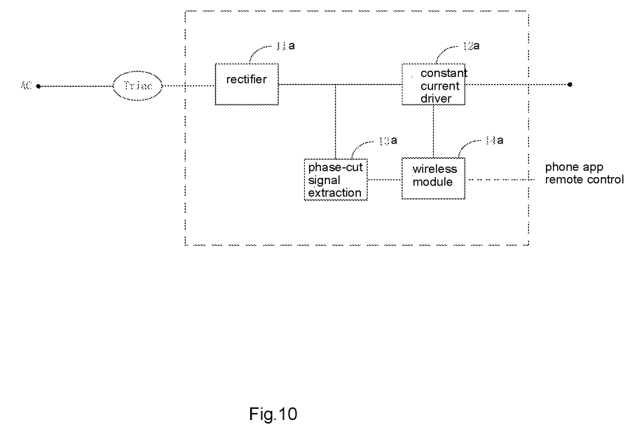

FIG. 10 is a schematic structural diagram of an LED driver circuit according to an embodiment of the present invention. The input end of the LED driver circuit is connected to an AC power supply via a TRIAC dimmer, and the output end of the LED driver circuit is used to drive an LED load.

Referring to FIG. 10, the LED driver circuit includes: a rectification module 11a, a constant-current driving module 12a, a phase-cut signal extraction module 13a, and a wireless communication module 14a.

The input of the rectification module 11a is connected to the input of the LED driver circuit, and the output of the rectification module 11a is connected to both the input of the constant-current driving module 12a and the input of the phase-cut signal extraction module 13a.

A first signal input of the wireless communication module 14a is connected to the output of the phase-cut signal extraction module 13a. A second signal input of the wireless communication module 14a is configured to receive wireless dimming signals from an external device. The output of the wireless communication module 14a is connected to the control terminal of the constant-current driving module 12a. The wireless communication module 14a is used to obtain the wireless dimming signal and the phase-cut signal from the phase-cut signal extraction module 13a, generate a target dimming signal based on both signals, and transmit it to the constant-current driving module 12a.

The output of the constant-current driving module 12a is connected to the output of the LED driver circuit and is used to control the output current based on the target dimming signal.

The phase-cut signal represents the firing angle of the TRIAC dimmer and affects the reference current. Without proper compatibility processing of the dimming signal, when the user adjusts the TRIAC dimmer, the reference current will change. If the constant-current driving module 12a continues to operate according to the initial reference current, dimming anomalies such as flickering may occur.

In the embodiment of the present invention, referring to FIG. 10, the wireless communication module 14a receives a wireless dimming signal from an external device (such as a mobile app or remote controller) and simultaneously obtains the phase-cut signal through the phase-cut signal extraction module 13a. Compatibility processing is then performed to generate a target dimming signal, which controls the constant-current driving module 12a. This ensures precise current regulation regardless of whether the TRIAC dimmer is at a high or low angle, avoiding flickering at small angles and significantly enhancing the compatibility of the driver circuit. Moreover, users can control the lighting simultaneously through both the TRIAC dimmer and smart wireless dimming, meeting diverse user preferences. The driver circuit can be directly installed in power lines with an existing TRIAC dimmer without requiring its removal, thus simplifying installation and improving adaptability.

In one possible embodiment, generating the target dimming signal based on the wireless dimming signal and the phase-cut signal, and transmitting it to the constant-current driving module 12a, may include:

Generating a constant-current reference signal based on the phase-cut signal, multiplying the constant-current reference signal with the wireless dimming signal to obtain the target dimming signal, and transmitting the target dimming signal to the constant-current driving module 12a.

In this embodiment of the present invention, the phase-cut signal reflects the firing angle of the TRIAC dimmer, which determines the magnitude of the reference current. In existing constant-current drive architectures, the reference current is typically treated as fixed. When the TRIAC dimmer’s angle changes, the reference current changes accordingly, which may not match the preset parameters of the constant-current driving module 12, leading to issues like flickering at small angles. To address this, the embodiment multiplies the constant-current reference signal and the wireless dimming signal, dynamically adjusts the reference current, and ensures that the parameters of the constant-current drive architecture match the actual reference current. This design improves the compatibility of the LED driver circuit.

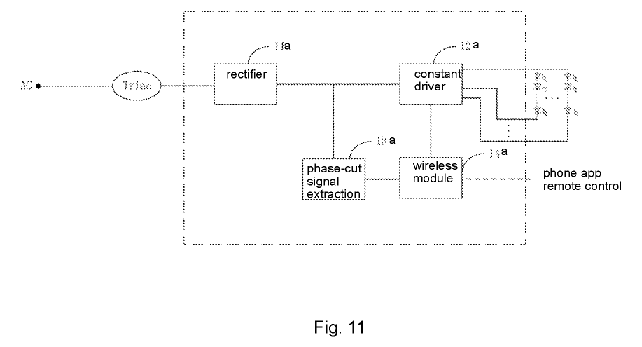

In one possible embodiment, referring to FIG. 11, the LED load may include at least one LED string. The constant-current driving module 12a may include a positive driving terminal and at least one negative driving terminal, with the number of negative driving terminals corresponding to the number of LED strings. The positive driving terminal is connected to the positive terminals of the LED strings, and the negative driving terminals are each connected one-to-one to the negative terminals of the LED strings.

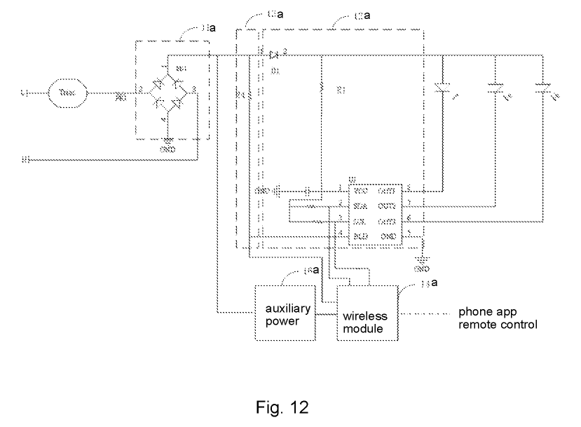

Referring to FIG. 12, the constant-current driving module 12a may include: a first diode D1, a first resistor R1, and a constant-current driving chip U1.

The power supply terminal of the constant-current driving chip U1 is connected via the first resistor R1 to both the cathode of the first diode D1 and the positive driving terminal. The control signal input terminal of the constant-current driving chip U1 is connected to the control terminal of the constant-current driving module 12a. Each drain driving terminal of the constant-current driving chip U1 is connected one-to-one to each negative driving terminal.

The anode of the first diode D1 is connected to the input of the constant-current driving module 12a.

The constant-current driving chip U1 is configured to control the current of each drain driving terminal based on the target dimming signal.

To achieve dimming and color tuning, multiple LED strings are typically configured. For example, referring to FIG. 12, three LED strings are used as RGB sources. The three LED strings mix to achieve adjustable color and brightness. In this embodiment, the constant-current driving chip U1 allocates current to each LED string according to the target dimming signal—i.e., it controls the current of each drain driving terminal, thereby realizing precise dimming.

The first diode D1 provides unidirectional conduction, preventing back-end signals from affecting the front-end circuit and ensuring accurate phase-cut signal extraction. The first resistor R1 supplies power to the constant-current driving chip U1.

Other peripheral components shown in FIG. 12 are implemented using conventional techniques and are not elaborated upon here.

In one possible embodiment, the rectification module 11a may include: a bridge rectifier BD1, as shown in FIG. 12.

Referring to FIG. 12, a fuse FR1 may also be provided between the TRIAC dimmer and the rectification module 11a for overcurrent protection.

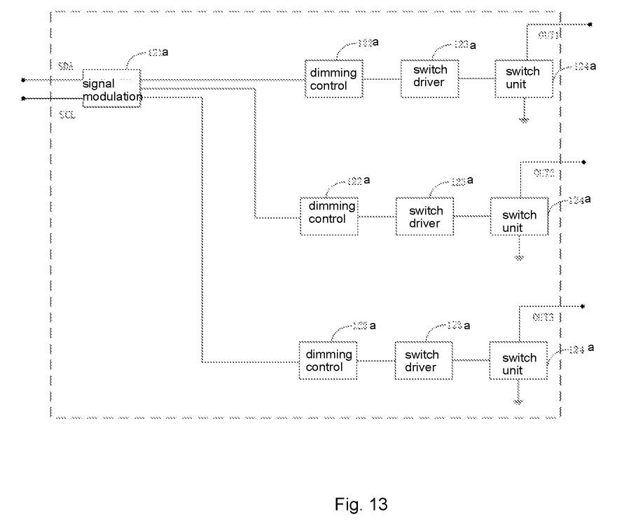

In one possible embodiment, referring to FIG. 13, the constant-current driving chip U1 may include: a signal modulation unit 121a, at least one dimming control unit 122a (DIM Control), at least one switching driver unit 123a, and at least one switching unit 124a. Each dimming control unit 122a corresponds one-to-one with a switching driver unit 123a and a switching unit 124a.

The input of the signal modulation unit 121a is connected to the control signal input terminal of the constant-current driving chip U1, and each output of the signal modulation unit 121a is connected one-to-one with the input of each dimming control unit 122a. The signal modulation unit 121a is configured to generate a secondary dimming signal for each corresponding dimming control unit 122a based on the target dimming signal. The secondary dimming signal is a PWM signal.

For any dimming control unit 122a, its output is connected to the input of the corresponding switching driver unit 123a. The output of the switching driver unit 123a is connected to the control terminal of the corresponding switching unit 124a. The first terminal of the switching unit 124a is connected to the drain driving terminal corresponding to the dimming control unit 122a, and the second terminal of the switching unit 124a is grounded. The dimming control unit 122a is configured to generate a reference voltage based on the secondary dimming signal. The switching driver unit 123a generates a switching control signal according to the reference voltage and controls the conduction of the switching unit 124a, thereby controlling the current of the corresponding drain driving terminal.

For the constant-current driving chip U1, the signal modulation unit 121a is used to process the target dimming signal. For example, when the number of LED strings is two or more, the target dimming signal is an I²C signal. The signal modulation unit 121a converts the I²C signal into separate secondary dimming signals (PWM signals) corresponding to each LED string. The dimming control unit 122 generates a reference voltage (VRef1, VRef2, VRef3) based on the secondary dimming signals, and the reference voltage reflects the current of each drain driving terminal. The switching driver unit 123 controls the conduction of the switching unit 124a based on the reference voltage, thereby regulating the current at each drain driving terminal.

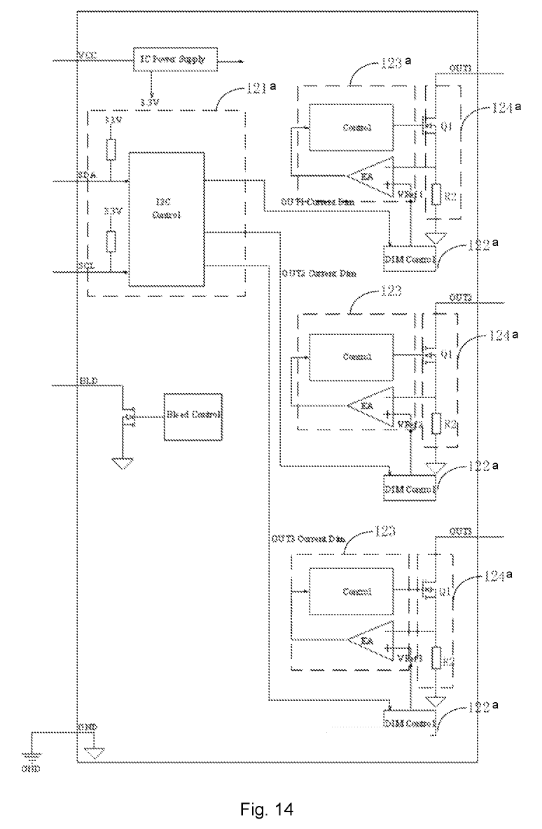

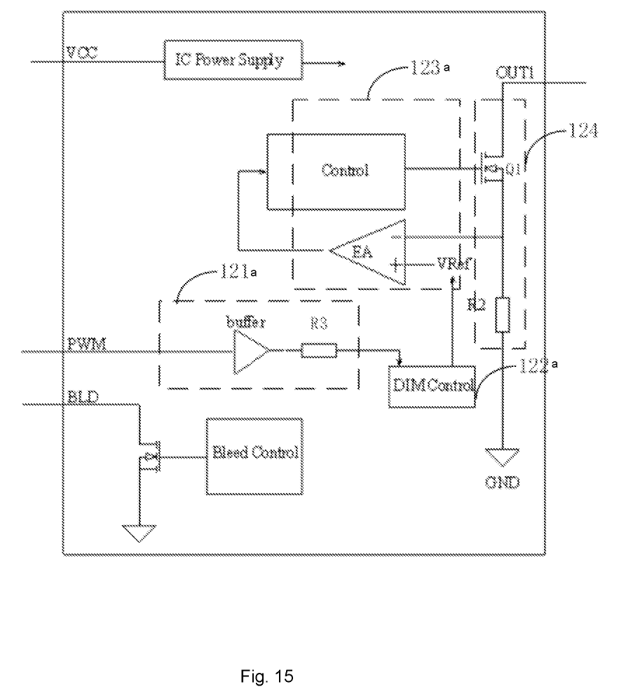

In one possible embodiment, referring to FIG. 14 and FIG. 15, the switching unit 124a may include: a first switching transistor Q1 and a second resistor R2.

The first terminal of the first switching transistor Q1 is connected to the first terminal of the switching unit 124a. The control terminal of the first switching transistor Q1 is connected to the control terminal of the switching unit 124a. The second terminal of the first switching transistor Q1 is connected to the second terminal of the switching unit 124a through the second resistor R2.

The first switching transistor Q1 forms the switching unit 124a within the constant-current driving chip U1, which can be efficiently implemented using standard chip processes.

It should be noted that the above embodiment is merely one possible configuration. The first switching transistor Q1 and the second resistor R2 may also be implemented externally instead of being integrated into the constant-current driving chip U1. This detail is not specifically limited herein.

In one possible embodiment, referring to FIG. 14 and FIG. 15, the switching driver unit 123a may include: an error amplifier EA and a drive signal modulation subunit labeled “Control.”

The positive input of the error amplifier EA is connected to the input of the switching driver unit 123a. The negative input of the error amplifier EA is connected to both the second terminal of the first switching transistor Q1 and the second resistor R2. The output of the error amplifier EA is connected to the input of the drive signal modulation subunit “Control.”

The output of the drive signal modulation subunit “Control” is connected to the output of the switching driver unit 123a.

In this embodiment, the current at the drain driving terminal is controlled by the reference voltage (VRef1, VRef2, VRef3), and the drain current is proportional to the reference voltage. When the current at a drain driving terminal is below a preset threshold, the error amplifier EA amplifies the difference and outputs a high-level signal, which increases the duty cycle of the first switching transistor Q1, thereby increasing the current. Conversely, when the current exceeds the preset threshold, the error amplifier EA amplifies the negative error and outputs a low-level signal to reduce the duty cycle, thereby decreasing the current. This configuration enables precise current control at each drain driving terminal.

In one possible embodiment, referring to FIG. 15, when there is only one LED string, the target dimming signal is a PWM signal. In this case, the signal modulation unit 121a may include: a buffer and a third resistor R3.

The input of the buffer is connected to the input of the signal modulation unit 121a, and the output of the buffer is connected to the output of the signal modulation unit 121a through the third resistor R3.

When the target dimming signal is a PWM signal, no signal format conversion is required. Therefore, only the third resistor R3 and the buffer are used for signal buffering to improve the stability and reliability of the signal.

When there are multiple LED strings, for example as shown in FIG. 14 with three LED strings, the target dimming signal may be an I²C signal. In this case, a dedicated chip is needed to process the I²C signal. The specific circuit of the signal modulation unit 121a may refer to FIG. 14 and follows conventional technical practices, so it is not elaborated upon here.

It should be noted that the number of drain driving terminals of the constant-current driving chip can be adjusted according to actual application requirements. As an example, FIG. 14 shows an internal block diagram of a chip with three drain driving terminals, while FIG. 15 shows one with a single drain driving terminal.

Furthermore, the internal power supply and grounding configurations of the chip are based on conventional techniques and are not described in detail here.

In one possible embodiment, referring to FIG. 12, the phase-cut signal extraction module 13a may include: a fourth resistor R4.

The first terminal of the fourth resistor R4 is connected to the input of the phase-cut signal extraction module 13a, and the second terminal is connected to its output.

In one possible embodiment, referring to FIG. 6, the LED driver circuit may further include: a constant-voltage module 15a.

The input of the constant-voltage module 15a is connected to both the output of the rectification module 11a and the input of the phase-cut signal extraction module 13a. The output of the constant-voltage module 15a is connected to the input of the constant-current driving module 12a.

The output voltage of the constant-voltage module 15a is constant. In this embodiment, the constant-voltage module 15a is configured to regulate the supply voltage of the LED, thereby improving the stability of the LED driver circuit. The circuit diagram of the constant-voltage module 15a may refer to FIG. 7 and is not elaborated upon here.

In one possible embodiment, referring to FIG. 6, the LED driver circuit may further include: an auxiliary power module 16a.

The input of the auxiliary power module 16a is connected to the output of the rectification module 11a and is used to supply power to the wireless communication module 14a.

Corresponding to the embodiments described above, the present invention also provides a lighting fixture comprising any of the LED driver circuits described in the above embodiments. This lighting fixture possesses the same advantages as those LED driver circuits, and further details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus supporting dual-mode dimming-compatible power control, comprising:
a TRIAC signal detection circuit configured to detect a phase-cut dimming signal from a TRIAC wall dimmer;
a digital dimming signal input configured to receive a smart control signal selected from an I²C signal or a PWM signal;
a control processor communicatively coupled to the TRIAC signal detection circuit and the digital dimming signal input, the control processor configured to perform a real-time mathematical operation combining the phase-cut dimming signal and the smart control signal; and
a power regulation circuit configured to drive an LED load by adjusting an output current in response to a result of the real-time mathematical operation.

2. The lighting apparatus of claim 1, wherein the real-time mathematical operation is a multiplication of the phase-cut dimming signal and the smart control signal.

3. The lighting apparatus of claim 1, wherein the power regulation circuit comprises a constant-current driver.

4. The lighting apparatus of claim 1, wherein the power regulation circuit comprises a linear power supply with multiple output channels.

5. The lighting apparatus of claim 1, wherein the digital dimming signal input comprises a pair of I²C input pins including an SDA pin and an SCL pin.

6. The lighting apparatus of claim 1, wherein the digital dimming signal input comprises a PWM input pin.

7. The lighting apparatus of claim 1, wherein the output current is modulated by adjusting a reference voltage used in current sampling.

8. The lighting apparatus of claim 1, further comprising a wireless communication module configured to receive the smart control signal via Zigbee, WiFi, or BLE.

9. The lighting apparatus of claim 8, wherein the wireless communication module is configured to transmit the smart control signal to the control processor.

10. The lighting apparatus of claim 1, wherein the control processor and the power regulation circuit are integrated into a single integrated circuit.

11. The lighting apparatus of claim 1, wherein the TRIAC signal detection circuit comprises a comparator and a voltage divider network coupled to an AC input.

12. The lighting apparatus of claim 1, wherein the control processor is further configured to output a PWM signal based on the phase-cut dimming signal.

13. The lighting apparatus of claim 1, further comprising a constant-voltage stage configured to convert an AC input to a PWM signal based on the phase-cut dimming signal.

14. The lighting apparatus of claim 13, wherein the PWM signal is supplied to the digital dimming signal input of a separate constant-current driver.

15. The lighting apparatus of claim 1, wherein the power regulation circuit comprises at least three output channels for separately controlled LED segments.

16. The lighting apparatus of claim 1, wherein the apparatus is operable in a TRIAC-only dimming mode or a digital-dimming-only mode.

17. The lighting apparatus of claim 1, wherein the real-time mathematical operation is performed using an internal multiplier circuit within the control processor.

18. The lighting apparatus of claim 1, wherein the control processor includes logic to prioritize the smart control signal over the phase-cut dimming signal in the event of a conflict.

19. The lighting apparatus of claim 1, wherein the power regulation circuit further comprises an over-voltage protection system and an over-current protection system.

20. The lighting apparatus of claim 1, wherein the apparatus is configured to operate with existing TRIAC dimmer installations without requiring modification to building wiring.
